(19) United States
(12) Patent Application Publication
(10) Pub. No.: US 2017/0348644 A1
(43) Pub. Date: Dec. 7, 2017

(54) METHOD FOR PRODUCING HOLLOW FIBER MEMBRANE AND HOLLOW FIBER MEMBRANE-SPINNING NOZZLE

(71) Applicant: Mitsubishi Chemical Corporation, Tokyo (JP)

(72) Inventors: Masahiko MIZUTA, Otake-shi (JP); Katsuhiko SHINADA, Toyohashi-shi (JP); Toshinori SUMI, Otake-shi (JP)

(73) Assignee: Mitsubishi Chemical Corporation, Tokyo (JP)

(21) Appl. No.: 15/539,776

(22) PCT Filed: Sep. 3, 2015
(86) PCT No.: PCT/JP2015/075054

§ 371 Date: Jun. 26, 2017

(51) Int. Cl. B01D 69/08; B01D 69/10; B01D 67/00; B01D 69/12; D01D 5/24; B01D 71/34

(52) U.S. Cl. CPC B01D 69/087; D01D 5/24; B01D 71/34; B01D 69/085; B01D 67/0016; B01D 69/125; B01D 69/10; B01D 2323/42; B01D 2325/40

(57) ABSTRACT

A method for manufacturing a hollow fiber membrane has a spinning step of applying a first membrane forming stock solution and a second membrane forming stock solution for forming a porous membrane layer to the outer peripheral surface of a hollow porous base material using a nozzle for hollow fiber membrane spinning and solidifying these membrane forming stock solutions, wherein a draft ratio (V_{B}/V_{A}), which is the ratio of feed velocity V_{B} for hollow porous base material fed out from a base material feed opening to linear velocity V_{A} for the first membrane forming stock solution and the second membrane forming stock solution discharged from a membrane forming stock solution discharge opening of the nozzle for hollow fiber membrane spinning, is set to 1-6.

### TECHNICAL FIELD

The present invention relates to a hollow fiber membrane-spinning nozzle for producing a hollow fiber membrane by applying a fiber-forming dope capable of forming a porous membrane layer on the peripheral surface of a long hollow porous substrate. The present invention also relates to a method for producing a hollow fiber membrane using the hollow fiber membrane-spinning nozzle.

### BACKGROUND ART

Due to tightened regulations and growing concerns over environmental pollution in recent years, people have shown interest in water treatment that uses filtration membranes characterized by compact size and complete separation capability. For such water treatment purposes, filtration membranes are required to exhibit excellent separation capability and permeability along with even higher mechanical properties than before.

As for a pressure-resistant porous filtration membrane, a hollow fiber membrane is known to have a porous membrane layer formed on the peripheral surface of a hollow porous substrate.

For example, Patent Literature 1 proposes a method for producing a hollow fiber membrane as follows: after a round cord is passed through a liquid immersion bath for a defoaming process, the round cord and a film-forming dope containing a phase-separable film-forming resin are fed out from a double-ring hollow fiber membrane-spinning nozzle and are spun by a wet or a dry-wet spinning process.

Furthermore, Patent Literature 2 proposes a hollow fiber membrane-spinning nozzle, capable of suppressing a gas from being entrapped in a composite consisting of a long hollow porous substrate and a film-forming dope so as to prevent abnormal outer diameter portions caused by entrapped gases and defective film portions caused by locally thinned film. The hollow fiber membrane-spinning nozzle is structured to have a substrate feed port for feeding a long hollow porous substrate to be inserted into a membrane, and a circular ring-shaped dope discharge port positioned to surround the substrate feed port on its outer side so as to discharge a film-forming dope in the direction in which the hollow porous substrate is fed out. Moreover, the hollow fiber membrane-spinning nozzle is structured to have a flow channel for exhausting the gas existing in a space of the region from the nozzle tip to the point where the film-forming dope is adhered (laminated) to the peripheral surface of the hollow porous substrate outside the nozzle.

### CITATION LIST

### Patent Literature

Patent Literature 1: JP H05-7746A

Patent Literature 2: JP2007-126783A

### DISCLOSURE OF INVENTION

### Problems to be Solved by the Invention

When a hollow fiber membrane is produced using the above hollow fiber membrane-spinning nozzle, the discharged film-forming dope may be disturbed because of equipment vibrations, variations in the feed rate of a hollow porous substrate, bubbles entrapped in the film-forming dope, uneven spinnability of the film-forming dope, and the like. When methods for producing hollow fiber membranes in Patent Literatures 1 and 2 are employed under such conditions, the film-forming dope may be temporarily detached from the hollow porous substrate in the region outside the nozzle where the film-forming dope is designed to be adhered to the peripheral surface of the hollow porous substrate.

As described above, when a film-forming dope is detached from a hollow porous substrate during the spinning process at the point outside the nozzle where the film-forming dope is designed to be adhered to the peripheral surface of the hollow porous substrate, the film-forming dope fails to follow the hollow porous substrate that continues coming out from the nozzle at a constant speed. As a result, the film-forming dope grows into a large drip-shaped mass near the dope discharge port outside the nozzle. Hereinafter, the film-forming dope that has grown into a mass is referred to as an abnormally discharged portion.

When the film-forming dope continues to be discharged from the dope discharge port under the above conditions, the abnormally discharged portion grows into an even greater mass and is reattached to the peripheral surface of the hollow porous substrate, thus resuming the process for applying the film-forming dope to the hollow porous substrate. However, the peripheral surface of the hollow porous substrate will have a bare portion since no film-forming dope is applied thereon between the time of dope detachment and the time of dope reattachment. In addition, the thickness of the film-forming dope is locally made greater where the abnormally discharged portion is reattached to the peripheral surface of the hollow porous substrate. Such variations in the application of the film-forming dope result in a defective hollow fiber membrane.

Especially, when a greater abnormally discharged portion exists on a hollow porous substrate during the production process of a hollow fiber membrane, an extra process is required to remove the defective portion at the time of product inspection. Moreover, during rinsing, drying, winding steps and the like subsequent to the spinning step, process failure may arise such as the hollow fiber membrane becoming clogged at the abnormally discharged portion when it passes through the narrow aperture of the equipment, the abnormally discharged portion becoming entangled with another spindle of hollow fiber membrane and causing damage, or the like. Therefore, it is important to prevent the formation of abnormally discharged portions, and if it happens, to reduce their sizes.

The present invention has been carried out to solve the above problems. Its objective is to provide a hollow fiber membrane production method capable of suppressing the detachment of a film-forming dope from a hollow porous substrate at the point outside the nozzle where the film-forming dope is designed to adhere to the peripheral surface of the hollow porous substrate, and also capable of promptly reattaching the film-forming dope even if it is detached from the hollow porous substrate, so that the formation of defects caused by abnormally discharged portions of the film-forming dope is prevented while also preventing process failure during steps subsequent to the spinning step. Moreover, its objective is to provide a hollow fiber membrane-spinning nozzle to be used in such a production method.

### Solutions to the Problems

The present invention is characterized by the following aspects.
[1] A method for producing a hollow fiber membrane using a hollow fiber membrane-spinning nozzle structured as below, the method including a spinning step for applying and coagulating a film-forming dope on the peripheral surface of a hollow porous substrate to form a porous membrane layer; in the method, the linear velocity (V_{A}) of discharging the film-forming dope from the dope discharge port relative to the feed rate (V_{B}) of feeding out the hollow porous substrate from the substrate feed port is set to have a draft ratio (V_{B}/V_{A}) of 1 to 6.

### (Hollow Fiber Membrane-Spinning Nozzle)

A hollow fiber membrane-spinning nozzle, structured to have a substrate insertion hole for the hollow porous substrate to be inserted and a dope flow channel for the film-forming dope to be distributed, in which a ring-shaped dope discharge port for discharging the film-forming dope distributed through the dope flow channel is formed on the outer side of a substrate feed port with a tube-shaped wall disposed between them so as to surround the substrate feed port for feeding out the hollow porous substrate coming through the substrate insertion hole.
[2] The method for producing a hollow fiber membrane according to [1], in which the aperture area of the dope discharge port is no greater than 3 times the cross-sectional area of the hollow porous substrate cut perpendicular to its longitudinal direction.
[3] The method for producing a hollow fiber membrane according to [1] or [2], in which the aperture area of the dope discharge port is no greater than 15 mm².
[4] The method for producing a hollow fiber membrane according to [3], which uses a film-forming dope with a viscosity at 40° C. set to be 30,000 mPa·s or higher.
[5] A hollow fiber membrane-spinning nozzle for applying a film-forming dope to form a porous membrane layer on the peripheral surface of a hollow porous substrate, structured to have a substrate insertion hole into which the hollow porous substrate is to be inserted and a dope flow channel through which the film-forming dope is to be distributed, where a ring-shaped dope discharge port for discharging the film-forming dope distributed through the dope flow channel is formed on the outer side of a substrate feed port with a tube-shaped wall disposed between them so as to surround the substrate feed port for feeding out the hollow porous substrate coming through the substrate insertion hole, and the thickness of the tip end of the tube-shaped wall is 0.1 mm to 0.75 mm.
[6] The hollow fiber membrane-spinning nozzle according to [5], in which the aperture area of the dope discharge port is no greater than 3 times the cross-sectional area, cut to be perpendicular to a longitudinal direction, of the hollow porous substrate to be inserted in the substrate insertion hole.
[7] The hollow fiber membrane-spinning nozzle according to [5] or [6], in which the aperture area of the dope discharge port is no greater than 15 mm².
[8] The hollow fiber membrane-spinning nozzle according to any of [5] to [7], in which the diameter of the substrate feed port is 1.01 times to 1.20 times the diameter of the hollow porous substrate inserted in the substrate insertion port.
[9] The hollow fiber membrane-spinning nozzle according to any of [5] to [8], in which a straight portion having the same diameter as that of the dope discharge port and a length of at least 1 mm is formed in the dope flow channel extending from near the dope discharge port to the dope discharge port.
[10] The hollow fiber membrane-spinning nozzle according to any of [5] to [9], in which a diameter tapering portion is arranged in the dope flow channel near the dope discharge port to have a diameter decreasing toward the dope discharge port.
[11] The hollow fiber membrane-spinning nozzle according to any of [5] to [10], in which a branching-merging mechanism is formed in the dope flow channel and the film-forming dope passes through the flow channel while branching and merging repeatedly.
[12] The hollow fiber membrane-spinning nozzle according to any of [5] to [11], in which at least two dope flow channels are formed, and a dope lamination portion is formed for the dope flow channels to merge near the dope discharge port so that film-forming dopes coming from the dope flow channels are formed into a composite laminate inside the nozzle.
[13] The hollow fiber membrane-spinning nozzle according to any of [5] to [12], in which at least two dope flow channels are formed, each dope flow channel is structured to have a dope distribution hole for distributing a film-forming dope and a ring-shaped dope reservoir for the film-forming dope coming through the dope distribution hole to be stored on the outer side of the substrate insertion hole, and the dope reservoir for storing a film-forming dope to be laminated on the outer side is shifted in an axis direction of the substrate insertion hole so as to be located on the downstream side of the dope reservoir for storing a film-forming dope to be laminated on the inner side.
[14] The hollow fiber membrane-spinning nozzle according to [13], in which the dope distribution holes are formed to have an interval at least 60 degrees apart from each other around the central axis of the substrate insertion hole.
[15] The hollow fiber membrane-spinning nozzle according to any of [11] to [14], in which the branching-merging mechanism is a porous element and the film-forming dope passes through the element while repeatedly branching and merging.
[16] The hollow fiber membrane-spinning nozzle according to any of [11] to [14], in which the dope flow channel is structured to have a dope reservoir where the film-forming dope is stored in a ring shape on the outer side of the substrate insertion hole, and the branching-merging mechanism is a filler layer with particles filled inside the dope reservoir.
[17] The hollow fiber membrane-spinning nozzle according to any of [11] to [14], in which the dope flow channel is structured to have a dope reservoir where the film-forming dope is stored in a ring shape on the outer side of the substrate insertion hole, and the dope reservoir is vertically divided into two or more storage cells.
[18] The hollow fiber membrane-spinning nozzle according to [13], in which a delay mechanism is formed in the dope flow channel to delay the passage of a film-forming dope, and the delay mechanism is set to be a meandering portion that causes the film-forming dope to meander vertically between the dope reservoir and the dope shaping portion for forming the film-forming dope into a tube shape.

### Effects of the Invention

According to the present invention, a film-forming dope is suppressed from being detached from a hollow porous substrate at a position outside the nozzle where the dope is designed to be attached to the peripheral surface of the substrate, and even if a film-forming dope is detached from a hollow porous substrate, the dope is promptly reattached to the substrate. Therefore, occurrence of defects caused by an abnormally discharged portion of a film-forming dope and process failure in subsequent steps are prevented.

### BRIEF DESCRIPTION OF THE DRAWINGS

FIG. 1 is a cross-sectional view schematically showing a hollow fiber membrane-spinning nozzle according to an embodiment of the present invention;

FIG. 2 is a view showing an end surface corresponding to the arrow-A view of the hollow fiber membrane-spinning nozzle in FIG. 1 according to an embodiment of the present invention;

FIG. 3 is a view showing the end surface corresponding to the arrow-A view of the hollow fiber membrane-spinning nozzle in FIG. 1 according to an embodiment of the present invention with added cross sections of a hollow porous substrate and a film-forming dope;

FIG. 4 is a view showing the B-B cross-section of the hollow fiber membrane-spinning nozzle in FIG. 1;

FIG. 5 is a view showing the C-C cross-section of the hollow fiber membrane-spinning nozzle in FIG. 1;

FIG. 6 is a view showing the D-D cross-section of the hollow fiber membrane-spinning nozzle in FIG. 1;

FIG. 7 is a cross-sectional view schematically showing a hollow fiber membrane-spinning nozzle according to another embodiment of the present invention;

FIG. 8 is a cross-sectional view schematically showing a hollow fiber membrane-spinning nozzle according to yet another embodiment of the present invention;

FIG. 9 is a plan view schematically showing the second nozzle block of the hollow fiber membrane-spinning nozzle according to the yet another embodiment of the present invention;

FIG. 10 is a cross-sectional view schematically showing a hollow fiber membrane-spinning nozzle according to yet another embodiment of the present invention;

FIG. 11 is a plan view schematically showing the second nozzle block of the hollow fiber membrane-spinning nozzle according to the yet another embodiment of the present invention; and

FIG. 12 is a cross-sectional view schematically showing a hollow fiber membrane-spinning nozzle according to yet another embodiment of the present invention.

### DETAILED DESCRIPTION OF THE EMBODIMENTS

### [Hollow Fiber Membrane-spinning Nozzle]

The hollow fiber membrane-spinning nozzle related to the present invention is used for producing a hollow fiber membrane structured to have a porous membrane layer on the peripheral surface of a hollow porous substrate (support body). The hollow fiber membrane-spinning nozzle related to the present invention may be used for producing a hollow fiber membrane structured to have a single porous membrane layer or to have two or more porous membrane layers.

The following is a description of a hollow fiber membrane-spinning nozzle to be used in a production method of a hollow fiber membrane related to the present invention.

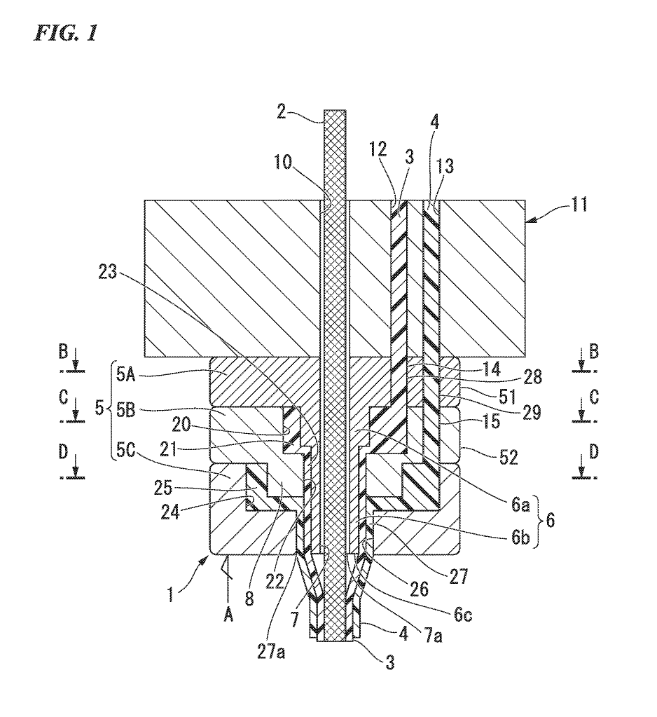

A hollow fiber membrane-spinning nozzle 1 according to an embodiment of the present invention (hereinafter referred to as spinning nozzle 1) is used for producing a hollow fiber membrane structured to have a double-layered porous membrane consisting of an inner layer and an outer layer formed on the peripheral surface of a hollow porous substrate. As shown in FIG. 1, spinning nozzle 1 is structured to allow detachable substrate insertion hole 10, which is for inserting hollow porous substrate 2, to be fixed with screws or the like to the downstream-side end surface of vertically installed metallic mounting plate 11.

Mounting plate 11 is formed in a circular shape on a plan view, and substrate insertion hole 10 is formed along its axis. Substrate insertion hole 10 penetrates mounting plate 11 from the upstream-side end surface through the downstream-side end surface.

In addition to substrate insertion hole 10, first intake hole 12 and second intake hole 13 each for introducing a film-forming dope are formed in mounting plate 11. First and second intake holes 12, 13 are located on the outer side of substrate insertion hole 10 to be apart from each other when seen on a plan view of mounting plate 11, and are formed parallel to substrate insertion hole 10 from the upstream-side end surface through the downstream-side end surface of mounting plate 11.

First film-forming dope 3 for forming an inner porous membrane layer is introduced into first intake hole 12. Second film-forming dope 4 for forming an outer porous membrane layer is introduced into second intake hole 13.

Spinning nozzle 1 is structured to have triple-layered nozzle main body 5 consisting of first nozzle block 5A, second nozzle block 5B and third nozzle block 5C each formed in a columnar shape and consecutively stacked in that order from the mounting plate 11 side.

Although various materials may be used for forming nozzle main body 5, stainless steel (SUS) is preferred considering heat resistance, corrosion resistance, strength and the like.

As shown in FIGS. 1 and 4 to 6, first nozzle block 5A is structured to have columnar block main body 51 and circular tube-shaped protrusion 6, which is integrated with block main body 51 and protrudes from the center of the end surface opposite mounting plate 11.

Tube-shaped protrusion 6 is structured to have larger-diameter portion 6a on the base-end side and smaller-diameter portion 6b on the tip-end side. The axes of larger-diameter and smaller-diameter portions 6a, 6b correspond to each other.

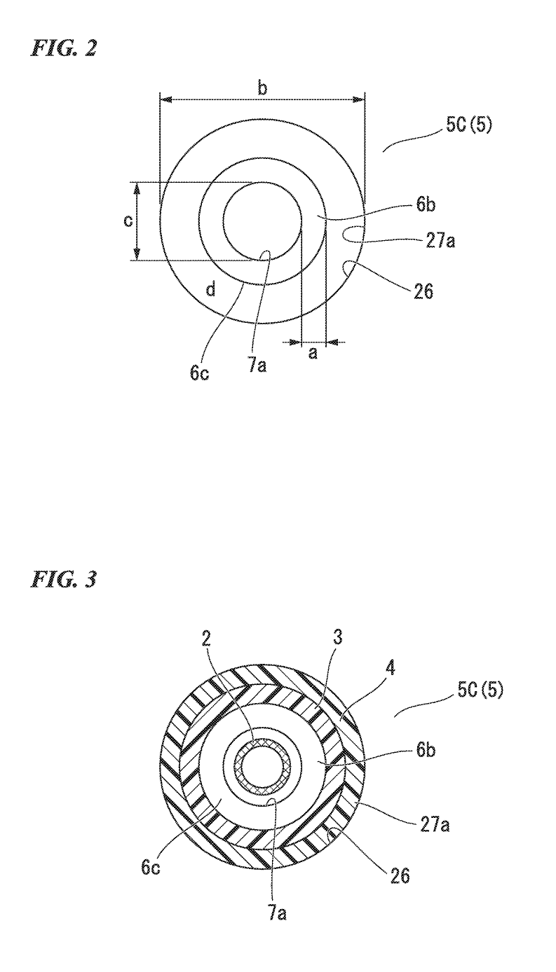

Substrate insertion hole 7 is formed in tube-shaped protrusion 6 to insert hollow porous substrate 2. Substrate insertion hole 7 is formed from the tip end of tube-shaped protrusion 6 to the mounting plate 11-side of block main body 51 so as to be connected to substrate insertion hole 10 formed in mounting plate 11. As shown in FIGS. 1 and 2, substrate feed port 7a is formed to feed out hollow porous substrate 2 coming through substrate insertion hole 7. Hollow porous substrate 2 inserted into substrate insertion hole 10 of mounting plate 11 passes through substrate insertion hole 7 of first nozzle block 5A and is fed out of substrate feed port 7a. It is an option to continuously draw hollow porous substrate 2 from substrate feed port 7a by using a winding roller or the like installed on the downstream side of spinning nozzle 1.

The diameter (c) of substrate feed port 7a (FIG. 2) is preferred to be 1.01 to 1.20 times, more preferably 1.05 to 1.15 times, the diameter of hollow porous substrate 2 to be inserted in substrate insertion hole 7. If the diameter of substrate feed port 7a is set to be at least the above lower limit, the substrate is suppressed from becoming stuck in the substrate insertion hole so as to improve the feeding stability of the substrate. If the diameter of substrate feed port 7a is set to be no greater than the above upper limit, first and second film-forming dopes 3,4 discharged from dope discharge port 27a are adhered to the peripheral surface of hollow porous substrate 2 with a smaller angle relative to the substrate.

As shown in FIGS. 1, 5 and 6, second nozzle block 5B is structured to have columnar block main body 52 and circular tube-shaped protrusion 8, which is integrated with block main body 52 and protrudes from the center of the end surface opposite mounting plate 11.

Recess 20, which is shaped to be circular on a plan view, is formed on the block main body 51-side end surface of block main body 52. The inner diameter of recess 20 is formed to be greater than the outer diameter of larger-diameter portion 6a of tube-shaped protrusion 6, and the inner wall surface of recess 20 is formed to surround larger-diameter portion 6a. The space between recess 20 and larger-diameter portion 6a in nozzle main body 5 is set to be circular ring-shaped first dope reservoir 21. The center of circular ring-shaped first dope reservoir 21 corresponds to the axis of larger-diameter portion 6a of tube-shaped protrusion 6.

As shown in FIGS. 1 and 4, first dope distribution hole 14 is formed in block main body 51 of first nozzle block 5A and block main body 52 of second nozzle block 5B, which are stacked. When seen on a plan view, first dope distribution hole 14 is positioned to be on the outer side of substrate insertion hole 7 in block main body 51, corresponding to the outer periphery of recess 20 in block main body 52, and is formed parallel to substrate insertion hole 7 from the upstream-side end surface of block main body 51 to recess 20. The bottom of first dope distribution hole 14 is made flush with the bottom of recess 20.

First dope distribution hole 14 is connected to first intake hole 12 so that first film-forming dope 3 introduced into first intake hole 12 flows into first dope distribution hole 14.

The cross-sectional shape cut perpendicular in a longitudinal direction of first dope distribution hole 14 is preferred to be circular. However, that is not the only option. In addition, the diameter of first dope distribution hole 14 is not limited to a particular size.

First film-forming dope 3 coming through first dope distribution hole 14 flows into first dope reservoir 21. In first dope reservoir 21, first film-forming dope 3 distributed through first dope distribution hole 14 is stored in a circular ring shape around larger-diameter portion 6a of tube-shaped protrusion 6. More specifically, first film-forming dope 3 flowed into first dope reservoir 21 from first dope distribution hole 14 is branched into two arc-shaped streams, which merge on the opposite side of first dope distribution hole 14 to ultimately form a circular ring shape in first dope reservoir 21.

In the center of tube-shaped protrusion 8 on a plan view, penetrating hole 22 is connected to recess 20 and extends to the tip-end surface of tube-shaped protrusion 8. The inner diameter of penetrating hole 22 is set to be greater than the outer diameter of smaller-diameter portion 6b of tube-shaped protrusion 6 while the inner-wall surface of penetrating hole 22 is formed to surround smaller-diameter portion 6b. The space between penetrating hole 22 and smaller-diameter portion 6b is set to be cylindrical first dope shaping portion 23. The axis of cylindrical first dope shaping portion 23 corresponds to the axis of smaller-diameter portion 6b of tube-shaped protrusion 6.

First film-forming dope 3 formed in a circular ring shape in first dope reservoir 21 flows into first dope shaping portion 23 so as to be formed in a cylindrical shape.

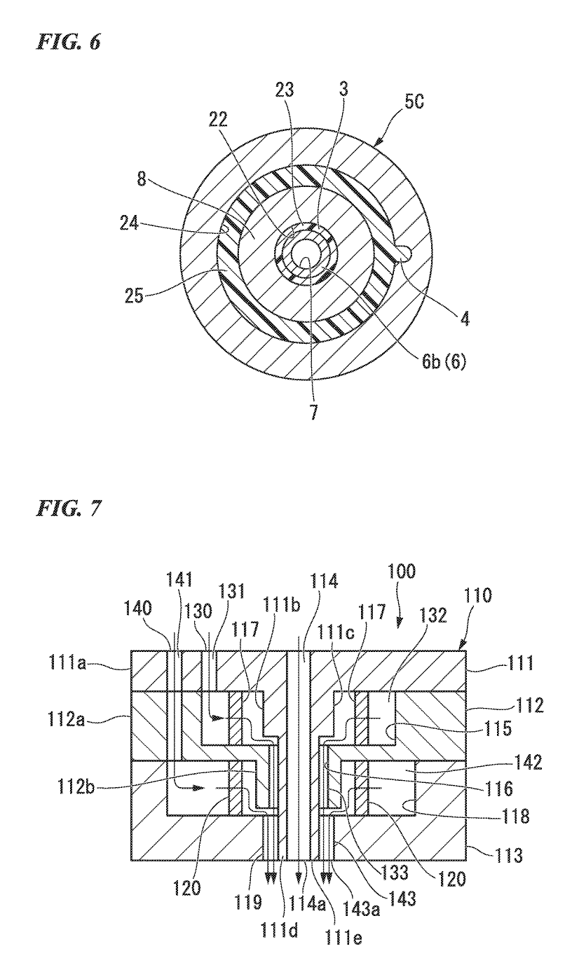

As shown in FIGS. 1 and 6, recess 24 in a circular shape on a plan view is formed on the block main body 52-side end surface of third nozzle block 5C. The inner diameter of recess 24 is formed greater than the outer diameter of tube-shaped protrusion 8 and its inner-wall surface is set to surround tube-shaped protrusion 8. The space between recess 24 and tube-shaped protrusion 8 in nozzle main body 5 is set to be circular ring-shaped second dope reservoir 25. The center of circular ring-shaped second dope reservoir 25 corresponds to the axis of smaller-diameter portion 6b of tube-shaped protrusion 6.

In spinning nozzle 1, first dope reservoir 21 is formed in block main body 52 of second nozzle block 5B, and second dope reservoir 25 is formed in third nozzle block 5C positioned on the downstream side of second nozzle block 5B. Namely, second dope reservoir 25 for storing second film-forming dope 4 to be laminated on the outer-layer side is shifted in an axis direction of substrate insertion hole 7 so as to be positioned on the downstream side of first dope reservoir 21 for storing first film-forming dope 3 to be laminated on the inner-layer side. As structured in spinning nozzle 1 related to the present invention, a dope reservoir for storing a film-forming dope to be laminated on the outer-layer side is shifted in an axis direction of the substrate insertion hole so as to be positioned on the downstream side of another dope reservoir for storing a film-forming dope to be laminated on the inner-layer side. By so setting, the spinning nozzle is designed compact in a width direction, enhancing the processing efficiency and productivity of the film-forming apparatus.

Second dope distribution hole 15 is formed where block main body 51 of first nozzle block 5A, block main body 52 of second nozzle block 5B and third nozzle block 5C are stacked together. When seen on a plan view, second dope distribution hole 15 is formed to be on the outer side of first dope distribution hole 14 in block main bodies 51, 52, corresponding to the outer periphery of recess 24 in third nozzle block 5C, and is formed parallel to substrate insertion hole 7 from the upstream-side end surface of block main body 51 to recess 24. The bottom surface of second dope distribution hole 15 is made flush with the bottom surface of recess 24.

Second dope distribution hole 15 is connected with second intake hole 13 so that second film-forming dope 4 introduced into second intake hole 13 flows into second dope distribution hole 15.

The shape of a cross section perpendicular to a longitudinal direction of second dope distribution hole 15 is preferred to be circular. However, that is not the only option. The diameter of second dope distribution hole 15 is not limited to a particular size.

In the embodiment above, first dope distribution hole 14 and second dope distribution hole 15 are formed in such a way that substrate insertion hole 7, first dope distribution hole 14 and second dope distribution hole 15 align linearly on a plan view.

In the present invention, it is an option to arrange multiple dope distribution holes to be separated at intervals of 60 degrees or greater around the central axis of the substrate insertion hole when seen on a plan view. It is preferred to arrange multiple dope distribution holes as above, since origination points of cracking that may occur in an axis direction are dispersed among layers, and formation of cracking is thereby suppressed.

First film-forming dope 3 coming through second dope distribution hole 15 flows into second dope reservoir 25. In second dope reservoir 25, second film-forming dope 4 coming through second dope distribution hole 15 is stored in a circular ring shape around tube-shaped protrusion 8. More specifically, second film-forming dope 4 coming through second dope distribution hole 15 enters second dope reservoir 25 and is branched into two arc-shaped streams, which merge on the opposite side of second dope distribution hole 15 to ultimately form a circular ring shape in second dope reservoir 25.

In the center of third nozzle block 5C on a plan view, penetrating hole 26 is connected to recess 24 and extends to the end surface opposite second nozzle block 5B. The inner diameter of penetrating hole 26 is greater than the outer diameter of smaller-diameter portion 6b of tube-shaped protrusion 6, and the inner-wall surface of penetrating hole 26 is formed to surround smaller-diameter portion 6b. In addition, the inner diameter of penetrating hole 26 is set slightly greater than the inner diameter of penetrating hole 22.

The space between penetrating hole 22 and smaller-diameter portion 6b in nozzle main body 5 is set to be cylindrical dope lamination portion 27. The axis of cylindrical dope lamination portion 27 corresponds to the axis of smaller-diameter portion 6b of tube-shaped protrusion 6.

Second film-forming dope 4 formed in a circular ring shape in second dope reservoir 25 flows into dope lamination portion 27 and is laminated on the outer side of first film-forming dope 3 to be a composite laminate while being formed in a cylindrical shape.

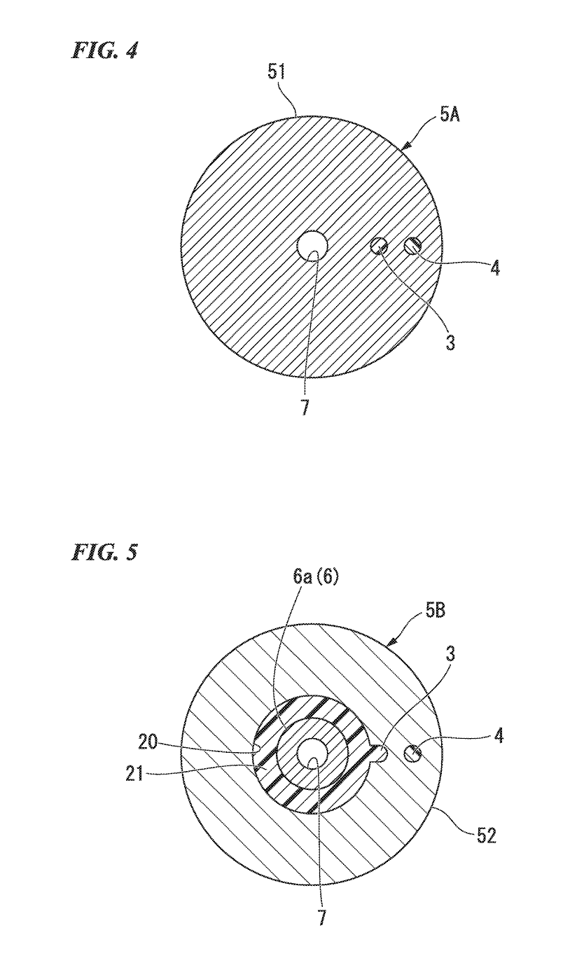

As shown in FIGS. 1 to 3, on the end surface of third nozzle block 5C positioned opposite second nozzle block 5B, circular ring-shaped dope discharge port 27a is formed as an opening end of dope lamination portion 27.

Dope discharge port 27a is positioned to surround substrate feed port 7a on its outer side, but is separated from substrate feed port 7a by tube-shaped wall 6c, which is the tip of smaller-diameter portion 6b of tube-shaped protrusion 6.

As described above, nozzle main body 5 is structured to have first dope flow channel 28, which includes first dope distribution hole 14, first dope reservoir 21 and first dope shaping portion 23, and to have second dope flow channel 29, which includes second dope distribution hole 15 and second dope reservoir 25. First dope flow channel 28 and second dope flow channel 29 merge at dope lamination portion 27 near dope discharge port 27a in nozzle main body 5.

First film-forming dope 3 flowing through first dope flow channel 28 and second film-forming dope 4 flowing through second dope flow channel 29 become a composite laminate in dope lamination portion 27 with second film-forming dope 4 being laminated on the outer side of first film-forming dope 3; then, the composite laminate is discharged from dope discharge port 27a in a cylindrical shape. Cylindrical first and second film-forming dopes 3,4 discharged from dope discharge port 27a are continuously adhered to the peripheral surface of hollow porous substrate 2 fed out from substrate feed port 7a.

The thickness (a) (FIG. 2) of the tip of tube-shaped wall 6c is preferred to be 0.1 mm to 0.75 mm, more preferably 0.25 mm to 0.60 mm.

The thickness (a) of tube-shaped wall 6c set to be within the above range contributes to forming a smaller angle when first and second film-forming dopes 3,4 discharged from dope discharge port 27a are adhered to the peripheral surface of hollow porous substrate 2. Moreover, such a thickness contributes to forming a smaller angle when first and second film-forming dopes 3,4 are adhered and stretched diagonally by hollow porous substrate 2. Accordingly, first and second film-forming dopes 3,4 are consistently adhered to the peripheral surface of hollow porous substrate 2. Moreover, a thickness (a) of tube-shaped wall 6c set to be within the above range shortens the distance from when first and second film-forming dopes 3,4 are discharged from dope discharge port 27a to when the dopes are adhered to the peripheral surface of hollow porous substrate 2, which in turn shortens a duration of instability for first and second film-forming dopes 3,4 after they are discharged from dope discharge port 27a until they are adhered to the peripheral surface of hollow porous substrate 2.

Accordingly, it is easier to suppress the detachment of first and second film-forming dopes 3,4 from hollow porous substrate 2 at the position outside spinning nozzle 1 where first and second film-forming dopes 3,4 are designed to adhere to the peripheral surface of hollow porous substrate 2.

Furthermore, if thickness (a) of tube-shaped wall 6c is within the above range, even when first and second film-forming dopes 3,4 are detached from hollow porous substrate 2 at the position where the dopes are designed to adhere to the peripheral surface of hollow porous substrate 2, the distance is short between the resultant abnormally discharged portion and the peripheral surface of hollow porous substrate 2, thus making it shorter timewise before the abnormally discharged portion is reattached to the peripheral surface of hollow porous substrate 2. As a result, even when first and second film-forming dopes 3,4 are detached from hollow porous substrate 2, the dope reattachment occurs promptly, thereby resulting in a smaller abnormally discharged portion.

In addition, if thickness (a) of tube-shaped wall 6c is within the above range, it is easier to secure sufficient pressure-resistant strength at the tip of tube-shaped protrusion 6.

The aperture area (d) of dope discharge port 27a (FIG. 2) is preferred to be no greater than three times, more preferably 1 to 2.5 times, the cross-sectional area, cut to be perpendicular to the longitudinal direction, of hollow porous substrate 2 to be inserted in substrate insertion hole 7. By so setting, it is easier to suppress the detachment of first and second film-forming dopes 3,4 from hollow porous substrate 2 at the position outside spinning nozzle 1 where the dopes are designed to adhere to the peripheral surface of hollow porous substrate 2.

The aperture area (d) of dope discharge port 27a (FIG. 2) is preferred to be no greater than 15 mm², more preferably 1 mm² to 15 mm². If aperture area (d) of dope discharge port 27a is no greater than 15 mm², it is easier to suppress the detachment of first and second film-forming dopes 3,4 from hollow porous substrate 2 at the position outside spinning nozzle 1 where the dopes are designed to adhere to the peripheral surface of hollow porous substrate 2.

The outer diameter (b) of dope discharge port 27a (FIG. 2) is preferred to be 1 to 5 mm, more preferably 2 to 5 mm.

In the present embodiment, near the dope discharge port of a dope flow channel, a straight portion at least 1 mm long extending to the dope discharge port is preferred to be formed having the same diameter as the dope discharge port. In the present embodiment, dope lamination portion 27 near dope discharge port 27a for first and second dope flow channels 28, 29 is preferred to have a straight portion extending at least 1 mm from dope discharge port 27a to have the same diameter as dope discharge port 27a. By so setting, consistent downward discharge of film-forming dopes is achieved.

In addition, a diameter tapering portion is preferred to be formed near the dope discharge port of a dope flow channel to extend to the dope discharge port with its diameter decreasing toward the dope discharge port. For example, dope lamination portion 27 near dope discharge port 27a for first and second dope flow channels 28, 29 is preferred to have a diameter tapering portion, which extends to dope discharge port 27a while decreasing its diameter toward dope discharge port 27a. Since such a setting makes the distance shorter for film-forming dopes passing through a narrow passage, the pressure required to discharge film-forming dopes is set lower, thus enhancing production stability.

In the embodiments of the present invention, a branching-merging mechanism is preferred to be arranged so that a film-forming dope passes through the dope flow channel while repeatedly branching and merging. Such a structure makes it easier to suppress formation of originating points of cracking that may occur along an axis direction in the porous membrane layer of a produced hollow fiber membrane.

Examples of a branching-merging mechanism are a porous element through which a film-forming dope passes while repeatedly branching and merging.

An example of such a porous element is the one described in WO2012/070629, and it is preferred to be a porous material having a three-dimensional network structure. A three-dimensional porous network structure means three-dimensional passages are formed inside so that the flow of a film-forming dope that passes through the structure is not linear but branches vertically and horizontally.

Considering strength, heat conductivity, drug resistance and homogeneous structure, sintered metal fine particles are preferred to be used to form a porous element. However, such a structure is not the only option, and a porous element may be selected from among sintered metal fibers, metal-mesh laminates or sintered laminates, ceramic porous materials, porous-sheet laminates or sintered laminates, metal particle fillers and the like.

It is preferred to form a cylindrical porous element so that a film-forming dope passes through it from the outer peripheral surface toward the inner peripheral surface. In the embodiments of the present invention, it is especially preferable to install a cylindrical porous element inside a dope reservoir.

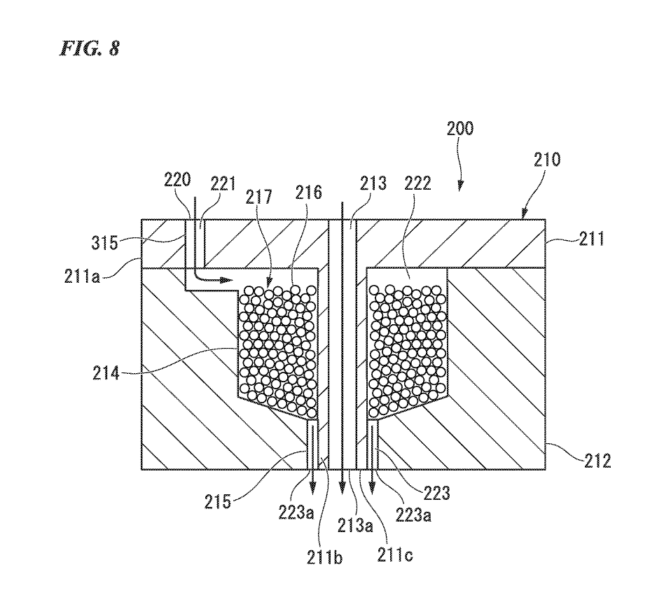

An example of a hollow fiber membrane-spinning nozzle having a porous element is hollow fiber membrane-spinning nozzle 100 as shown in FIG. 7 (hereinafter referred to as spinning nozzle 100).

Spinning nozzle 100 is structured to have triple-layered nozzle main body 110 consisting of first nozzle block 111, second nozzle block 112 and third nozzle block 113 which are consecutively stacked from the upper side in that order. First nozzle block 111, second nozzle block 112 and third nozzle block 113 are formed to be the same as first nozzle block 5A, second nozzle block 5B and third nozzle block 5C in spinning nozzle 1.

In block main body 111a and circular tube-shaped protrusion 111b in first nozzle block 111, substrate insertion hole 114 is formed to insert a hollow porous substrate. At the tip of tube-shaped protrusion 111b, substrate feed port 114a is formed to feed out the hollow porous substrate coming through substrate insertion hole 114.

In nozzle main body 110, the space between recess 115 formed in block main body 112a of second nozzle block 112 and larger-diameter portion 111c of tube-shaped protrusion 111b is set to be circular ring-shaped first dope reservoir 132. In block main body 111a of first nozzle block 111 and block main body 112a of second nozzle block 112, first dope distribution hole 131 is formed to be connected to first dope reservoir 132. The space between penetrating hole 116 formed in tube-shaped protrusion 112b of second nozzle block 112 and smaller-diameter portion 111d of tube-shaped protrusion 111b is set to be cylindrical first dope shaping portion 133.

Cylindrical porous element 117 is formed in first dope reservoir 132.

In nozzle main body 110, the space between recess 118 and tube-shaped protrusion 112b formed in third nozzle block 113 is set to be circular ring-shaped second dope reservoir 142. Second dope distribution hole 141 is formed in block main body 111a of first nozzle block 111, block main body 112a of second nozzle block 112 and third nozzle block 113, and is connected to second dope reservoir 142. The space between penetrating hole 119 formed in third nozzle block 113 and smaller-diameter portion 111d of tube-shaped protrusion 111b is set to be cylindrical dope lamination portion 143. On the lower end surface of third nozzle block 113, circular ring-shaped dope discharge port 143a is formed as an opening end of dope lamination portion 143.

Cylindrical porous element 120 is formed in second dope reservoir 142.

Dope discharge port 143a is positioned to surround substrate feed port 114a on its outer side, but is separated from substrate feed port 114a by tube-shaped wall 111e, which is the tip of smaller-diameter portion 111d of tube-shaped protrusion 111b.

The thickness of the tip of tube-shaped wall 111e is preferred to be 0.1 mm to 0.75 mm, more preferably 0.25 mm to 0.60 mm.

Spinning nozzle 100 is structured to have first dope flow channel 130 which includes first dope distribution hole 131, first dope reservoir 132 and first dope shaping portion 133, and to have second dope flow channel 140 which includes second dope distribution hole 141 and second dope reservoir 142. First dope flow channel 130 and second dope flow channel 140 merge at dope lamination portion 143.

The first film-forming dope coming through first dope distribution hole 131 flows into first dope reservoir 132 and is made into a circular ring shape on the outer side of porous element 117. The circular ring-shaped first film-forming dope passes through porous element 117 while minutely branching and merging from the outer peripheral surface toward the inner peripheral surface, and flows into first dope shaping portion 133.

In addition, the second film-forming dope coming through second dope distribution hole 141 flows into second dope reservoir 142 and is made into a circular ring shape on the outer side of porous element 120. The circular ring-shaped second film-forming dope passes through porous element 120 while minutely branching and merging from the outer peripheral surface toward the inner peripheral surface, and flows into first dope lamination portion 143, where the second film-forming dope is formed into a composite being laminated on the outer side of the first film-forming dope that has flowed from first dope reservoir 133. The composite laminate is then discharged from dope discharge port 143a. First and second film-forming dopes discharged through dope discharge port 143a are continuously adhered to the peripheral surface of the hollow porous substrate fed out from substrate feed port 114a.

It is an option to employ a filler layer, for example, where particles are filled inside a dope reservoir as the branching-merging mechanism.

Such particles may be shaped in a spherical, rectangular or filler form, an uneven three-dimensional structure or the like.

The material of particles is not limited particularly, and metals such as stainless steel and alloys, inorganic materials such as glass and ceramics, and resins such as Teflon® and polyethylene that are insoluble in film-forming dopes may be used. Specific examples of particles may include steel balls.

The size and number of particles may be determined appropriately as desired.

The height of filler layers may also be determined appropriately as desired.

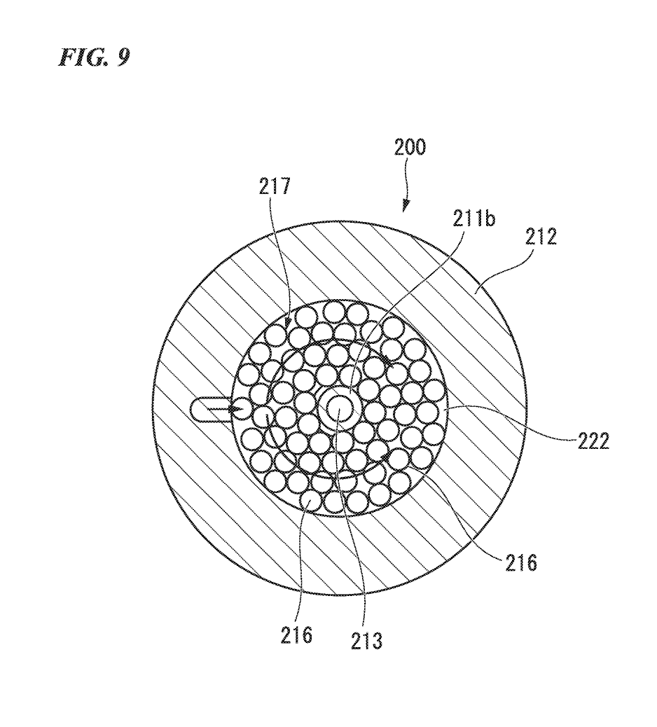

An example of a hollow fiber membrane-spinning nozzle with a filler layer is hollow fiber membrane-spinning nozzle 200 as shown in FIGS. 8 and 9 (hereinafter referred to as spinning nozzle 200). Spinning nozzle 200 is used for producing a hollow fiber membrane where a single porous membrane layer is laminated on the outer side of a hollow porous substrate.

Spinning nozzle 200 is structured to have double-layered nozzle main body 210 consisting of first nozzle block 211 and second nozzle block 212 which are stacked from the upper side in that order.

Substrate insertion hole 213 is formed to insert a hollow porous substrate in block main body 211a and circular tube-shaped protrusion 211b protruding downward from block main body 211a of first nozzle block 211. At the tip of tube-shaped protrusion 211b, substrate feed port 213a is formed to feed out the hollow porous substrate coming through substrate insertion hole 213.

In nozzle main body 210, the space between recess 214 formed on the upper portion of second nozzle block 212 and tube-shaped protrusion 211b is set to be circular ring-shaped dope reservoir 222. In first and second nozzle blocks 211, 212, dope distribution hole 221 is formed to be connected to dope reservoir 222. On the lower portion of second nozzle block 212, penetrating hole 215 is formed to be connected to recess 214. The space between penetrating hole 215 and tube-shaped protrusion 211b in nozzle main body 210 is set to be cylindrical dope shaping portion 223.

On the lower end surface of second nozzle block 212, circular ring-shaped dope discharge port 223a is formed as an opening end of dope shaping portion 223.

Filler layer 217 filled with particles 216 is formed in dope reservoir 222.

Dope discharge port 223a is positioned to surround substrate feed port 213a on its outer side but is separated from substrate feed port 213a by tube-shaped wall 211c, which is the tip of tube-shaped protrusion 211b.

The thickness of the tip of tube-shaped wall 211c is preferred to be 0.1 mm to 0.75 mm, more preferably 0.25 mm to 0.60 mm.

As described above, spinning nozzle 200 is structured to have dope flow channel 220, which includes dope distribution hole 221, dope reservoir 222 and dope shaping portion 223.

The film-forming dope coming through dope distribution hole 221 flows into dope reservoir 222, passes downward through the reservoir while minutely branching and merging through the filler layer 217, flows into dope shaping portion 223, and is finally discharged through dope discharge port 223a. The film-forming dope discharged from dope discharge port 223a is continuously adhered to the peripheral surface of a hollow porous substrate fed out of substrate feed port 213a.

When a dope flow channel is structured to have a dope reservoir in a hollow fiber membrane-spinning nozzle related to the present invention, the dope reservoir may be vertically divided into two or more dope storage cells. Such a structure suppresses formation of originating points of cracking that may occur in an axis direction in the porous membrane layer of a produced hollow fiber membrane.

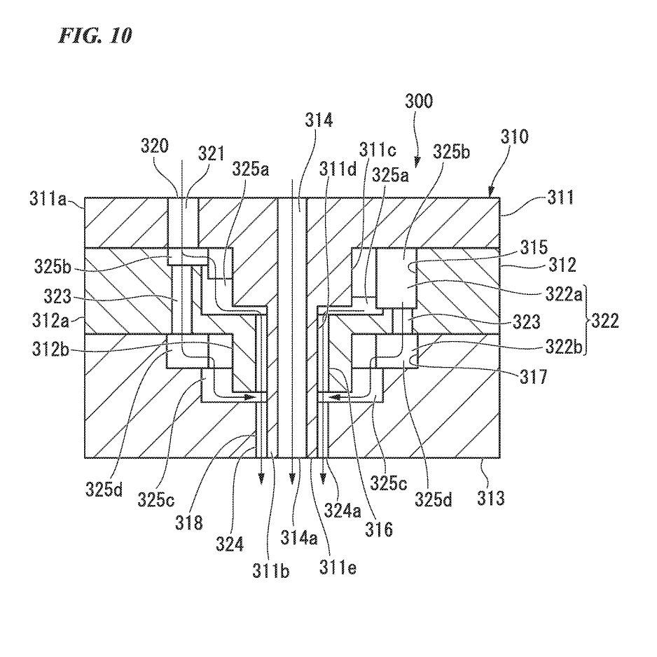

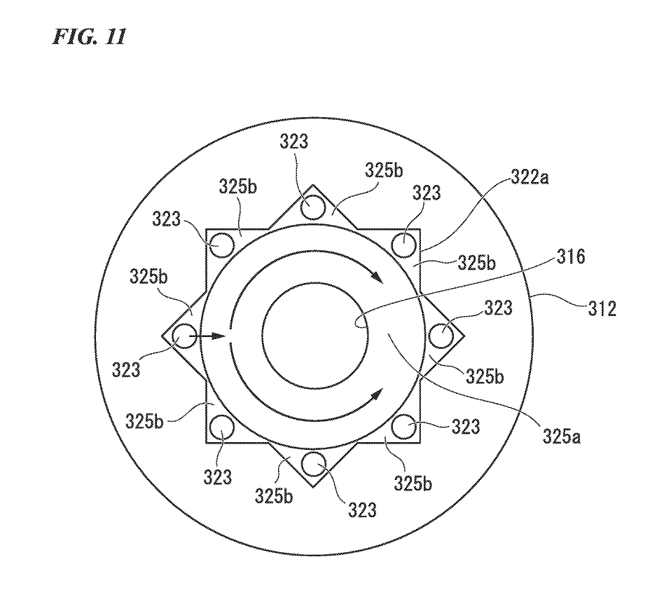

For example, a hollow fiber membrane-spinning nozzle related to the present invention may be a hollow fiber membrane-spinning nozzle 300 as shown in FIGS. 10 and 11 (hereinafter referred to as spinning nozzle 300).

Spinning nozzle 300 is structured to have triple-layered nozzle main body 310, consisting of first nozzle block 311, second nozzle block 312, and third nozzle block 313 consecutively stacked from the upper portion in that order.

Substrate insertion hole 314 is formed to insert a hollow porous substrate in block main body 311a and circular tube-shaped protrusion 311b protruding downward from block main body 311a in first nozzle block 311. At the tip of tube-shaped protrusion 311b, substrate feed port 314a is formed to feed out the hollow porous substrate coming through substrate insertion hole 314.

In nozzle main body 310, the space between recess 315 formed on the upper portion of block main body 312a of second nozzle block 312 and larger-diameter portion 311c of tube-shaped protrusion 311b is set to be first storage cell 322a. In addition, the space between recess 317 formed on the upper portion of third nozzle block 313 and tube-shaped protrusion 312b of second nozzle block 312 is set to be second storage cell 322b.

In block main body 311a of first nozzle block 311, dope distribution hole 321 is formed to be connected to first storage cell 322a. Moreover, in block main body 312a of second nozzle block 312, eight supply routes 323 connecting first storage cell 322a and second storage cell 322b are formed along the inner wall surface of block main body 312a. As described, spinning nozzle 300 is structured to have dope reservoir 322 which is vertically divided into double-stage first and second storage cells 322a, 322b.

First storage cell 322a is structured to have circular ring-shaped portion 325a with a circular ring-shaped cross section on a plan view, and eight peripheral portions 325b formed when portions of the inner wall surface of block main body 312a are indented outward from circular ring-shaped portion 325a. Eight supply routes 323 are respectively formed in eight peripheral portions 325b in first storage cell 322a. When seen on a plan view, one of peripheral portions 325b in first storage cell 322a corresponds to dope distribution hole 321.

In the above embodiment, eight peripheral portions 325b are formed in such a way that the bottom surfaces of peripheral portions 325b are lowered in stages from the dope distribution hole 321 side toward the opposite side. Forming height differences among peripheral portions 325b contributes to supplying a film-forming dope more evenly from each of supply routes 323 to second storage cell 322b.

Second storage cell 322b is structured to have circular ring-shaped portion 325c with a circular ring-shaped cross section on a plan view, and eight peripheral portions 325d are formed in the upper portion of circular ring-shaped portion 325c where portions of the inner wall surface of the third nozzle block are indented outward. The film-forming dope is supplied from eight supply routes 323 respectively to eight peripheral portions 325d.

In nozzle main body 310, a space is formed between penetrating hole 316, which is formed in tube-shaped protrusion 312b of second nozzle block 312, and smaller-diameter portion 311d of tube-shaped protrusion 311b; and another space is formed between penetrating hole 318, which is formed on the lower portion of third nozzle block 313 to be connected to recess 317, and smaller-diameter portion 311d of tube-shaped protrusion 311b. Those two spaces are set to be cylindrical dope shaping portion 324. On the lower end surface of third nozzle block 313, circular ring-shaped dope discharge port 324a is formed as an opening end of dope shaping portion 324.

Dope discharge port 324a is positioned to surround substrate feed port 314a on its outer side, but is separated from substrate feed port 314a by tube-shaped wall 311e, which is the tip of smaller-diameter portion 311d of tube-shaped protrusion 311b.

The thickness of the tip of tube-shaped wall 311e is preferred to be 0.1 mm to 0.75 mm, more preferably 0.25 mm to 0.60 mm.

As described above, spinning nozzle 300 is structured to have dope flow channel 320, which includes dope distribution hole 321, dope reservoir 322 and dope shaping portion 324.

The film-forming dope coming through dope distribution hole 321 flows into first storage cell 322a of dope reservoir 322, part of which is formed in a circular ring shape and flows into dope shaping portion 324 while the rest is supplied to second storage cell 322b from supply routes 323. The film-forming dope supplied to second storage cell 322b is formed in a circular ring shape and flows into dope shaping portion 324. Then, the film-forming dope coming through dope shaping portion 324 is discharged from dope discharge port 324a and adhered continuously to the peripheral surface of a hollow porous substrate fed out from substrate feed port 314a.

Moreover, a dope flow channel related to the present invention is preferred to have a delay mechanism capable of delaying the passage of film-forming dope through the nozzle. As for the delay mechanism, a meandering portion is preferred so as to cause the film-forming dope to vertically meander between the dope reservoir and dope shaping portion.

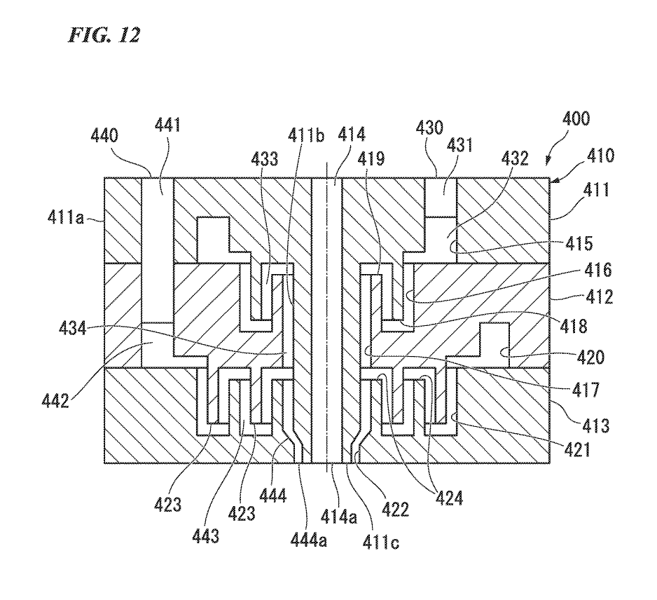

An example of a hollow fiber membrane-spinning nozzle may be hollow fiber membrane-spinning nozzle 400 as shown in FIG. 12 (hereinafter referred to as spinning nozzle 400).

Spinning nozzle 400 is structured to have triple-layered nozzle main body 410 consisting of first nozzle block 411, second nozzle block 412 and third nozzle block 413 which are consecutively stacked from the upper side in that order.

Substrate insertion hole 414 is formed to insert a hollow porous substrate in block main body 411a and circular tube-shaped protrusion 411b protruding downward from block main body 411a in first nozzle block 411. At the tip of tube-shaped protrusion 411b, substrate feed port 414a is formed to feed out the hollow porous substrate coming through substrate insertion hole 414.

On the lower end side of block main body 411a in first nozzle block 411, circular ring-shaped recess 415 is formed to surround tube-shaped protrusion 411b. The space in nozzle main body 410 between recess 415 and second nozzle block 412 is set to be dope reservoir 432. In block main body 411a, first dope distribution hole 431 is formed to be connected to first dope reservoir 432.

On the upper portion of second nozzle block 412, recess 416 is formed to be circular on a plan view. Recess 416 is formed in such a way that the inner wall surface of second nozzle block 412 surrounds tube-shaped protrusion 411b. In the center of recess 416, penetrating hole 417 is formed to extend to the lower end surface of second nozzle block 412.

From the lower end surface of first nozzle block 411, cylindrical first gate 418 is formed to surround tube-shaped protrusion 411b while hanging down into recess 415. The tip of first gate 418 is separated from the bottom of recess 416. In addition, around penetrating hole 417 at the bottom of recess 416 in second nozzle block 412, second gate 419 is formed rising up to be inside first gate 418. The tip of second gate 419 is separated from the lower end surface of first nozzle block 411. Because of such a structure, meandering portion 433 is formed in recess 416 so that the film-forming dope coming from first dope reservoir 432 flows vertically meandering through the structure toward the center while maintaining its circular ring shape.

The space between penetrating hole 417 and tube-shaped protrusion 411b in nozzle main body 410 is set to be cylindrical first dope shaping portion 434.

On the lower-end side of second nozzle block 412 and on the outer side of recess 416, circular ring-shaped recess 420 is formed to surround tube-shaped protrusion 411b. The space between recess 420 and third nozzle block 413 in nozzle main body 410 is set to be second dope reservoir 442. In block main body 411a of first nozzle block 411 and second nozzle block 412, second dope distribution hole 441 is formed to be connected to second dope reservoir 442.

Recess 421 shaped circular on a plan view is formed on the upper portion of third nozzle block 413. Recess 421 is formed in such a way that the inner wall surface of third nozzle block 413 surrounds tube-shaped protrusion 411b. In the center of recess 421, penetrating hole 422 is formed to extend to the lower-end surface of third nozzle block 413.

In recess 421, two each of cylindrical first and second gates 423, 424 are positioned alternately toward the center on a plan view to surround tube-shaped protrusion 411b by protruding respectively from the lower-end surface of second nozzle block 412 and the bottom surface of recess 421. The tip of each first gate 423 is separated from the bottom surface of recess 421. The tip of each second gate 424 is separated from the lower-end surface of second nozzle block 412. Because of such a structure, meandering portion 443 is formed in recess 421 so that the film-forming dope coming from second dope reservoir 442 flows vertically meandering through the structure toward the center while maintaining its circular ring shape.

The space between penetrating hole 422 and tube-shaped protrusion 411b in nozzle main body 410 is set to be cylindrical dope lamination portion 444. On the lower-end surface of third nozzle block 413, circular ring-shaped dope discharge port 444a is formed as the opening end of dope lamination portion 444.

Dope discharge port 444a is positioned to surround substrate feed port 414a on its outer side, but is separated from substrate feed port 414a by tube-shaped wall 411c, which is the tip of tube-shaped protrusion 411b.

The thickness of the tip of tube-shaped wall 411c is preferred to be 0.1 mm to 0.75 mm, more preferably 0.25 mm to 0.60 mm.

Spinning nozzle 400 is structured to have first dope flow channel 430 which includes first dope distribution hole 431, first dope reservoir 432, meandering portion 433 and first dope shaping portion 434 as well as second dope flow channel 440 which includes second dope distribution hole 441, second dope reservoir 442 and meandering portion 443. First dope flow channel 430 and second dope flow channel 440 merge at dope lamination portion 444.

The first film-forming dope coming through first dope distribution hole 431 flows into first dope reservoir 432 and is formed in a circular ring shape. Then, the first film-forming dope flows vertically meandering through meandering portion 433, and flows into first dope shaping portion 434.

The second film-forming dope coming through second dope distribution hole 441 flows into second dope reservoir 442 and is formed in a circular ring shape. Then, the second film-forming dope flows vertically meandering through meandering portion 443, and flows into dope lamination portion 444. In dope lamination portion 444, the second film-forming dope is laminated on the outer side of first film-forming dope coming from first dope shaping portion 434 to form a composite laminate. The first and second film-forming dopes are discharged from dope discharge port 444a and are continuously adhered to the peripheral surface of the hollow porous substrate fed out of substrate feed port 414a.

### [Method for Producing Hollow Fiber Membrane]

The hollow fiber membrane produced by the production method related to the present invention is structured to have a porous membrane layer formed on the peripheral surface of a hollow porous substrate (support body). The method for producing a hollow fiber membrane related to the present invention may be used for producing a hollow fiber membrane structured to have a single porous membrane layer or to have two or more porous membrane layers.

According to the present invention, the method for producing a hollow fiber membrane includes a spinning step. In such a method, a hollow fiber membrane-spinning nozzle is used to apply a film-forming dope for a porous layer on the peripheral surface of a hollow porous substrate, and the film-forming dope is coagulated by using a coagulation liquid. In the production method of a hollow fiber membrane according to the present invention, steps subsequent to the spinning process are conducted by a known method.

The following is a description of a method for producing a hollow fiber membrane related to the present invention. A method for producing a hollow fiber membrane related to the present invention may include spinning, rinsing, removing, drying and winding steps as described below, for example.

Spinning step: using a hollow fiber membrane-spinning nozzle, a film-forming dope for a porous layer is applied on the peripheral surface of a hollow porous substrate, and the film-forming dope is coagulated by using a coagulation liquid to obtain a hollow fiber membrane precursor;

Coagulating step: the film-forming dope applied on the peripheral surface of a hollow porous substrate is coagulated by a coagulation liquid to obtain a hollow fiber membrane precursor.

Rinsing step: the solvent remaining in the hollow fiber membrane precursor is rinsed off;

Removing step: the opening agent remaining in the rinsed hollow fiber membrane precursor is removed to form a hollow fiber membrane;

Drying step: the hollow fiber membrane is dried after the removal step; and

Winding step: the dried hollow fiber membrane is wound.

### (Spinning Step)

In the spinning step, the linear velocity (V_{A}) at which a film-forming dope discharged from the dope discharge port of a hollow fiber membrane-spinning nozzle and the feed rate (V_{B}) at which a hollow porous substrate is fed out from the substrate feed port are set to have a draft ratio (V_{B}/V_{A}) of 1 to 6 when the film-forming dope is applied on the peripheral surface of the hollow porous substrate.

When the draft ratio (V_{B}/V_{A}) is 1 to 6, the linear velocity (V_{A}) is sufficiently close to the feed rate (V_{B}). Thus, at the position where the film-forming dope is designed to be adhered to the peripheral surface of the hollow porous substrate, the film-forming dope is unlikely to be detached from the hollow porous substrate. Moreover, even when the film-forming dope is detached from the hollow porous substrate at the designated position, the dope is promptly reattached to the substrate, thus reducing the size of an abnormally discharged portion.

The draft ratio (V_{B}/V_{A}) is set to be 1 to 6, preferably 2 to 5.5.

The feed rate (V_{B}) of a hollow porous substrate to be fed out from a substrate feed port is preferred to be 10 to 50 m/min., more preferably 15 to 45 m/min.

In the embodiments of the present invention, the linear velocity (V_{A}) of a film-forming dope to be discharged from a dope discharge port is obtained when the amount of a film-forming dope supplied to the hollow fiber membrane-spinning nozzle using a gear pump or the like is divided by the aperture area of the dope discharge port. Also, the feed rate of a hollow porous substrate to be fed out of a substrate feed port is obtained from the rotation speed of a drive roller such as a winding roller positioned on the downstream side of a hollow fiber membrane-spinning nozzle so as to draw out the hollow porous substrate.

For example, when the aforementioned spinning nozzle 1 is used, hollow porous substrate 2 is introduced to substrate insertion hole 10 of mounting plate 11, first film-forming dope 3 is introduced into first intake hole 12, and second film-forming dope 4 is introduced into second intake hole 13. Hollow porous substrate 2 introduced into substrate insertion hole 10 is inserted into substrate insertion hole 7 of spinning nozzle 1, and is fed out from substrate feed port 7a. First and second film-forming dopes 3,4 introduced into first and second intake holes 12, 13 flow respectively through first and second dope flow channels 28, 29 of spinning nozzle 1. Next, the dopes are formed in cylindrical shapes at lamination portion 27, while forming a composite by laminating second film-forming dope 4 on the outer side of first film-forming dope 3. The composite laminate is then discharged from dope discharge port 27a. Outside the nozzle, first and second film-forming dopes 3,4 formed into a composite laminate and discharged from dope discharge port 27a are adhered to the peripheral surface of hollow porous substrate 2 fed out of substrate feed port 7a. Accordingly, first and second film-forming dopes 3,4 are applied on the peripheral surface of hollow porous substrate 2.

In the above step, the linear velocity (V_{A}) at which first and second film-forming dopes 3,4 are discharged from dope discharge port 27a and the feed rate (V_{B}) at which hollow porous substrate 2 is fed out from substrate feed port 7a are adjusted respectively so that the draft ratio (V_{B}/V_{A}) will be 1 to 6.

Examples of a hollow porous substrate are those known to be used for forming hollow fiber membranes. Specific examples are hollow braided or knitted cords made of various fibers such as polyester or polypropylene fibers. A hollow porous substrate may be one made of a single fiber material or in combination of multiple fiber materials.

Examples of fibers used for forming hollow braided or knitted cords are synthetic or semi-synthetic fibers, recycled fibers, natural fibers and the like. Fibers may have any form, for example, monofilament, multifilament, spun yarns or the like.

Moreover, a hollow porous substrate may be a porous hollow fiber membrane obtained by a melt-drawing technique. It is yet another option to use those obtained by immersing the aforementioned hollow porous substrate into a film-forming auxiliary liquid, or by applying a film-forming auxiliary liquid to the peripheral surface of the aforementioned hollow porous substrate.

Considering the productivity of a substrate and result of adhering a porous membrane layer to the substrate, a hollow porous substrate is preferred to be a braided cord made of a single multifilament.

A hollow porous substrate may take any form as long as it has at least one hollow portion in a cross section perpendicular to a longitudinal direction of the substrate extending in a longitudinal direction so that a liquid is transferred from the peripheral surface to the hollow portion and further transferred in the longitudinal direction.

Moreover, the cross-sectional shape of the hollow of a hollow porous substrate and the peripheral shape of the substrate cross section are not limited to a particular shape, and may be circular or irregular. In addition, the cross-sectional shape of the hollow of a hollow porous substrate and the peripheral shape of the substrate cross section may be the same as or different from each other. Considering pressure resistance, shape formation and the like, the peripheral shape of a substrate cross section is preferred to be circular.

The outer diameter of a hollow porous substrate is preferred to be 0.3 mm to 5 mm. Since variations in the outer diameter of a hollow porous substrate affect the quality such as spinning stability and film thickness, it is preferred to select a hollow porous substrate capable of maintaining a consistent outer diameter.

For example, when using a hollow porous substrate having a circular cross section perpendicular to a longitudinal direction and an outer diameter of 0.3 mm to 5 mm, the variation rate of the outer diameter of the hollow porous substrate is preferred to be no greater than ±0.3 mm.

In the embodiments of the present invention, heat treatment is preferred to be conducted on a hollow porous substrate before it is inserted into the substrate insertion hole of a spinning nozzle. Such a treatment reduces expansion/contraction rates of the hollow porous substrate, thereby stabilizing the outer diameter size.

As for film-forming dopes, any known types used for forming a porous layer of a hollow fiber membrane may be used. A film-forming dope is a solution obtained when a film-forming resin and an opening agent to control phase separation are dissolved in an organic solvent that is a good solvent for such components.

The film-forming resin is selected from generally used resins for forming the porous membrane layer of a hollow fiber membrane; specific examples are resins such as polysulfone, polyether sulfone, sulfonated polysulfone, polyvinylidene fluoride, polyacrylonitrile, polyimide, polyamide-imide, polyesterimide and the like.

They may be selected appropriately as desired. Among them, polyvinylidene fluoride is especially preferable because of its excellent drug resistance properties.

Examples of an opening agent are hydrophilic polymers such as monool, diol and triol represented by polyethylene glycols, polyvinylpyrrolidone and the like. They may be selected appropriately as desired. Among them, polyvinylpyrrolidone is preferred because of its excellent thickening effects.

Examples of an organic solvent are those capable of dissolving the film-forming resin and additives, and dimethyl sulfoxide, dimethylacetamide, dimethylformamide or the like may be used.

Any optional additive may be used unless it blocks the phase separation of the film-forming dope.

In the embodiments of the present invention, a film-forming dope is preferred to have a viscosity at 40° C. of 30,000 mPa·s or higher, more preferably 60,000 mPa·s or higher, even more preferably 150,000 mPa·s or higher. A higher viscosity of a film-forming dope makes it easier to make smaller pores in a porous membrane layer, thereby forming smaller voids and enhancing the quality of a hollow fiber membrane. Also, a higher draft ratio contributes to controlling the stability of film-forming dope discharged from a hollow fiber membrane-spinning nozzle.

As shown in the example using spinning nozzle 1, when two or more film-forming dopes are used to form two or more layers on the peripheral surface of a hollow porous substrate, the viscosity at 40° C. of at least one of the film-forming dopes is preferred to be 30,000 mPa·s or higher, more preferably 60,000 mPa·s or higher, even more preferably 150,000 mPa·s or higher.

The upper limit of viscosity at 40° C. of a film-forming dope is preferred to be 500,000 mPa·s, more preferably 300,000 mPa·s.

Furthermore, when two or more film-forming dopes are used to form two or more layers on the peripheral surface of a hollow porous substrate, the molecular weight distribution of a film-forming resin contained in at least one film-forming dope is preferred to be 3 or less, and the molecular weight distribution of the film-forming resin contained in the film-forming dope to be applied on the outer side is preferred to be wider than that of the film-forming resin contained in the film-forming dope to be applied on the inner side By so setting, it is easier to form a dense structure while maintaining water permeability.

The film-forming dope applied on the peripheral surface of a hollow porous substrate is coagulated by a coagulation liquid to form a hollow fiber membrane precursor. The film-forming dope on the hollow porous substrate is coagulated by the coagulation liquid as it is phase-separated.

In the embodiments of the present invention, from the viewpoint of enhancing water permeability, it is preferred to employ a dry-wet spinning method having a blank section where the hollow porous substrate with applied film-forming dope runs in air for a certain distance between the spinning nozzle and the coagulation liquid. However, it is an option to employ a wet spinning method so that a film-forming dope is discharged from the spinning nozzle directly into a coagulation liquid.

The coagulation liquid needs to be a solvent that does not dissolve the film-forming resin while it is a good solvent for an opening agent. Examples of a coagulation liquid are water, ethanol, methanol and the like, including a mixture thereof. Among them, a mixture of water and the solvent to be used for the film-forming dope is preferred considering the working environment and operational management.

### (Rinsing Step)

The obtained hollow fiber membrane precursor is rinsed off using a rinsing liquid so that the solvent remaining in the precursor is removed.

The rinsing liquid is preferred to be water considering its high rinsing effect. Examples of water are tap water, industrial water, river water, well water and the like. It is also an option to mix water with alcohols, inorganic salts, oxidants, surfactants and the like.

### (Removing Step)

The opening agent remaining in the rinsed hollow fiber membrane precursor is removed by using an oxidant to obtain a hollow fiber membrane. More specifically, the rinsed hollow fiber membrane precursor is immersed in a chemical solution containing an oxidant such as hypochlorite, and is heated in a gas phase so that the opening agent is oxidized and decomposed. Then, the precursor is rinsed in a rinsing solution to remove the opening agent.

When the opening agent remaining in the layer formed by coagulating the film-forming dope is removed from the hollow fiber membrane precursor, portions where the opening agent was present become pores to form a porous membrane layer. Accordingly, a hollow fiber membrane is obtained.

### (Drying Step)

The method for drying the obtained hollow fiber membrane is not limited specifically, and a dryer such as a hot air dryer may be used.

### (Winding Step)

The dried hollow fiber membrane is wound using a bobbin or the like.

When a film-forming dope is applied on the peripheral surface of a hollow porous substrate, the greater the draft ratio (V_{B}/V_{A}) is, the more stretched is the film-forming dope on the peripheral surface of the hollow porous substrate where the dope is adhered. Accordingly, the discharging process of a film-forming dope tends to be affected if the process is disturbed by causes such as equipment vibrations, change in feed rates of the hollow porous substrate, bubbles entrapped in the dope, variations in spinnability of the dope and the like. As a result, the film-forming dope tends to be detached from the hollow porous substrate at the position outside the nozzle where the dope is designed to be adhered to the peripheral surface of the substrate.

By contrast, using the production method of a hollow fiber membrane according to the present invention, a draft ratio (V_{B}/V_{A}) controlled to be 1 to 6 during the spinning process reduces the degree of stretching the film-forming dope adhered to the outer periphery of the hollow porous substrate. Thus, even if the discharging process of a film-forming dope is disturbed, adhesion of the film-forming dope is less likely to be affected. As a result, the film-forming dope is suppressed from being detached from the hollow porous substrate at the position outside the nozzle where the dope is designed to be adhered to the peripheral surface of the substrate. Moreover, even if the film-forming dope is detached, it will be promptly reattached to the hollow porous substrate, thus preventing occurrence of defective portions caused by the abnormally discharged portion of the film-forming dope and process failure in the subsequent steps.

The present invention is not limited to the aforementioned embodiments, and various design modifications are possible within a range that does not deviate from the gist of the present invention.

The method for producing a hollow fiber membrane according to the present invention may be a method for forming a hollow fiber membrane structured to have a single porous membrane layer, or to have two or more porous membrane layers.

In the following the present invention is described in further detail by referring to examples. However, the present invention is not limited to those examples.

### EXAMPLE 1

A hollow fiber membrane was prepared using spinning nozzle 1 shown in FIGS. 1 to 6.

As for hollow porous substrate 2, five polyester fibers (fineness: 84 dtex, number of filaments: 36) were combined and knitted using a round knitting machine to form a round hollow knitted cord. A continuous heat drawing treatment was conducted on hollow porous substrate 2 using a 200° C. heating die (aperture diameter of 2.5 mm) at the upstream of spinning nozzle 1 so as to provide the substrate with low expansion contraction properties and outer diameter stability. The outer diameter of hollow porous substrate 2 was 2.5 mm and its inner diameter was 1.5 mm.

Film-forming dope (R1) having the composition makeup specified in Table 1 was used as first film-forming dope 3, and film-forming dope (R2) having the composition makeup specified in Table 1 was used as second film-forming dope 4. Raw materials shown below were used:

polyvinylidene fluoride A: product name Kynar 301F, made by Arkema Co., Ltd.

polyvinylidene fluoride B: product name Kynar 9000HD, made by Arkema polyvinylpyrrolidone: product name PVP-K79, made by Nippon Shokubai Co., Ltd. N,N-dimethylacetamide

TABLE 1

| | Film-forming | | Film-forming | |
|---|---|---|---|---|
| | dope R1 | | dope R2 | |
| Polyvinylidene fluoride A | 12 | mass % | 20 | mass % |
| Polyvinylidene fluoride B | 12 | mass % | 0 | mass % |
| Polyvinylpyrrolidone | 12 | mass % | 10 | mass % |
| N,N-dimethylacetamide | 64 | mas % | 70 | mass % |
| Temperature of film-forming dope | 60° | C. | 60° | C. |
| Polyvinylidene fluoride concentration | 24 | mass % | 20 | mass % |
| in film-forming dope | | | | |

Spinning nozzle 1 was structured as follows: thickness (a) of tube-shaped 6c: 0.4 mm, outer diameter (b) of dope discharge port 27a: 4.52 mm, its inner diameter: 3.5 mm, aperture area: 6.42 mm². Moreover, when first and second film-forming dopes 3, 4 were applied on the peripheral surface of hollow porous substrate 2, linear velocity (V_{A}) of first and second film-forming dopes 3, 4 discharged from dope discharge port 27a was set at 5.63 m/min., feed rate (V_{B}) of hollow porous substrate 2 fed out from substrate feed port 7a was set at 15 m/min., and the draft ratio (V_{B}/V_{A}) was 2.7.

Next, first and second film-forming dopes 3,4 applied on the peripheral surface of hollow porous substrate 2 were immersed in a coagulation liquid in a coagulation bath to coagulate first and second film-forming dopes 3, 4, which were then pulled out of the bath, wound on a winding roller rotating at a constant speed of 15 m/min., and rinsed in 80 to 100° C. hot water. Accordingly, a hollow fiber membrane was obtained.

### EXAMPLES 2 TO 4, COMPARATIVE EXAMPLES 1, 2

Hollow fiber membranes were each prepared the same as in Example 1 except that the following were changed as specified in Table 2: thickness (a) of tube-shaped wall 6c, outer diameter (b) of dope discharge port 27a, its inner diameter and aperture area, linear velocity (V_{A}) of first and second film-forming dopes 3, 4, feed rate (V_{B}) of hollow porous substrate 2, and the draft ratio (V_{B}/V_{A}).

### [Evaluation Methods]

### (Size of Abnormally Discharged Portion)

When a hollow porous fiber membrane was obtained, the maximum outer diameter Tmax of an abnormally discharged portion on the peripheral surface of the hollow porous substrate 2 was measured to be set as the size of the abnormally discharged portion. If the maximum outer diameter Tmax is 4.5 mm or smaller, process failure is less likely to occur in the steps subsequent to the spinning step. Thus, hollow fiber membranes having a maximum outer diameter Tmax of 4.5 mm or smaller were evaluated as passing, and those having a maximum outer diameter of 4.5 mm or greater were evaluated as failing.

### (Number of Abnormally Discharged Portions)

The number of abnormally discharged portions per 1000 km length of a hollow fiber membrane.

When the number of abnormally discharged portions is less than one per 1000 km length of a hollow fiber membrane, it is allowable considering the frequency of process failure caused by the abnormally discharged portions and an increase in production cost incurred accordingly. Therefore, when the number of abnormally discharged portions was less than one per 1000 km length of hollow fiber membrane, the hollow fiber membrane was evaluated as passing, and if the number was 1 or more, the hollow fiber membrane was evaluated as failing.

Spinning conditions and evaluation results in Examples 1 to 4 and Comparative Examples 1, 2 are shown in Table 2.

TABLE 2

| | | | | | | Comp. | Comp. |
|---|---|---|---|---|---|---|---|
| | Unit | Example 1 | Example 2 | Example 3 | Example 4 | Example 1 | Example 2 |
| Thickness (a) of cylindrical wall 6c | mm | 0.4 | 0.4 | 0.1 | 0.6 | 0.8 | 0.4 |
| Outer dia. (b) of dope discharge port 27a | mm | 4.52 | 5.33 | 4.5 | 4.5 | 6.3 | 6.3 |
| Inner dia. (c + 2a) of dope discharge port 27a | mm | 3.5 | 3.5 | 2.9 | 3.9 | 4.1 | 3.5 |
| Aperture area of dope discharge port 27a | mm² | 6.42 | 12.69 | 9.3 | 3.96 | 17.97 | 21.55 |
| Linear velocity (V_{A}) of film-forming dope | m/min | 5.63 | 2.85 | 3.89 | 9.13 | 2.01 | 1.68 |
| Feed rate (V_{B}) of hollow porous substrate | m/min | 15 | 15 | 15 | 15 | 15 | 15 |
| Draft ratio (V_{B}/V_{A}) | — | 2.7 | 5.3 | 3.9 | 1.6 | 7.5 | 8.9 |
| Size of abnormally discharged portion | mm | 4.2 | 4.1 | 3.3 | 4.5 | 6.8 | 4.3 |
| (maximum outer dia. Tmax) | | | | | | | |
| Number of abnormally discharged portion | number | 0.61 | 0.82 | 0.54 | 0.96 | 3.34 | 3.65 |
| | per 1000 km | | | | | | |

In each of Examples 1 to 4, where the draft ratio (V_{B}/V_{A}) was set to be 1 to 6, the number of abnormally discharged portions per 1000 km length of hollow fiber membrane was less than one, and the maximum outer diameter Tmax of each abnormally discharged portion was 4.5 mm or smaller.

By contrast, in Comparative Example 1, where the draft ratio (V_{B}/V_{A}) was set to be above 6, the number of abnormally discharged portions per 1000 km length of hollow fiber membrane was 3.34, and the diameter of each abnormally discharged portion was 6.8 mm, which were beyond allowable ranges.

In Comparative Example 2, where the draft ratio (V_{B}/V_{A}) was also set to be above 6, the number of abnormally discharged portions per 1000 km length of hollow fiber membrane was 3.65, which was beyond the allowable range.

### DESCRIPTION OF NUMERICAL REFERENCES

1 hollow fiber membrane-spinning nozzle
2 hollow porous substrate
3 first film-forming dope
4 second film-forming dope
6c tube-shaped wall
7 substrate insertion hole
7a substrate feed port
14 first dope distribution hole
15 second dope distribution hole
21 first dope reservoir
23 first dope shaping portion
25 second dope reservoir
27 dope lamination portion
27a dope discharge port
28 first dope flow channel
29 second dope flow channel

1. A method for producing a hollow fiber membrane using a hollow fiber membrane-spinning nozzle configured as below, comprising:
a spinning step for applying and coagulating a film-forming dope on the peripheral surface of a hollow porous substrate to form a porous membrane layer,
wherein the linear velocity (V_{A}) of discharging the film-forming dope from the dope discharge port relative to the feed rate (V_{B}) of feeding out the hollow porous substrate from the substrate feed port is set to have a draft ratio (V_{B}/V_{A}) of 1 to 6, wherein the hollow fiber membrane-spinning nozzle is configured to have a substrate insertion hole for the hollow porous substrate to be inserted and a dope flow channel for the film-forming dope to be distributed, in which a ring-shaped dope discharge port for discharging the film-forming dope distributed through the dope flow channel is formed on the outer side of a substrate feed port with a tube-shaped wall disposed between them so as to surround the substrate feed port for feeding out the hollow porous substrate coming through the substrate insertion hole.

2. The method for producing a hollow fiber membrane according to claim 1, wherein the aperture area of the dope discharge port is set to be no greater than 3 times the cross-sectional area of the hollow porous substrate cut perpendicular to its longitudinal direction.

3. The method for producing a hollow fiber membrane according to claim 1, wherein the aperture area of the dope discharge port is set to be no greater than 15 mm².

4. The method for producing a hollow fiber membrane according to claim 1, set to use a film-forming dope having a viscosity at 40° C. of 30,000 mPa·s or higher.

5. A hollow fiber membrane-spinning nozzle for applying a film-forming dope to form a porous membrane layer on the peripheral surface of a hollow porous substrate, configured to have a substrate insertion hole into which the hollow porous substrate is to be inserted and a dope flow channel through which the film-forming dope is to be distributed,
wherein a ring-shaped dope discharge port for discharging the film-forming dope distributed through the dope flow channel is formed on the outer side of a substrate feed port with a tube-shaped wall disposed between them so as to surround the substrate feed port for feeding out the hollow porous substrate coming through the substrate insertion hole,
the thickness of the tip end of the tube-shaped wall is set at 0.1 mm to 0.75 mm, and the aperture area of the dope discharge port is set to be no greater than 15 mm².

6. The hollow fiber membrane-spinning nozzle according to claim 5, wherein the aperture area of the dope discharge port is set to be no greater than 3 times the cross-sectional area, cut to be perpendicular to a longitudinal direction, of the hollow porous substrate to be inserted in the substrate insertion hole.

7. (canceled)

8. The hollow fiber membrane-spinning nozzle according to claim 5, the diameter of the substrate feed port is set to be 1.01 times to 1.20 times the diameter of the hollow porous substrate inserted in the substrate insertion port.

9. The hollow fiber membrane-spinning nozzle according to claim 5, wherein a straight portion having the same diameter as that of the dope discharge port and a length of at least 1 mm is formed in the dope flow channel extending from near the dope discharge port to the dope discharge port.

10. The hollow fiber membrane-spinning nozzle according to claim 5, wherein a diameter tapering portion is arranged in the dope flow channel near the dope discharge port to have a diameter decreasing toward the dope discharge port.

11. The hollow fiber membrane-spinning nozzle according to claim 5, wherein a branching-merging mechanism is formed in the dope flow channel and the film-forming dope passes through the dope flow channel while branching and merging repeatedly.

12. The hollow fiber membrane-spinning nozzle according to claim 5, wherein at least two dope flow channels are formed, and a dope lamination portion is formed for the dope flow channels to merge near the dope discharge port so that film-forming dopes coming from the dope flow channels are formed into a composite laminate inside the nozzle.

13. The hollow fiber membrane-spinning nozzle according to claim 5, wherein at least two dope flow channels are formed, each dope flow channel is configured to have a dope distribution hole for distributing a film-forming dope and a ring-shaped dope reservoir for the film-forming dope coming through the dope distribution hole to be stored on the outer side of the substrate insertion hole, and the dope reservoir for storing a film-forming dope to be laminated on the outer side is shifted in an axis direction of the substrate insertion hole so as to be located on the downstream side of the dope reservoir for storing a film-forming dope to be laminated on the inner side.

14. The hollow fiber membrane-spinning nozzle according to claim 13, wherein the dope distribution holes are formed to have an interval at least 60 degrees apart from each other around the central axis of the substrate insertion hole.

15. The hollow fiber membrane-spinning nozzle according to claim 11, wherein the branching-merging mechanism is a porous element and the film-forming dope passes through the element while repeatedly branching and merging.

16. The hollow fiber membrane-spinning nozzle according to claim 11, wherein the dope flow channel is configured to have a dope reservoir where the film-forming dope is stored in a ring shape on the outer side of the substrate insertion hole, and the branching-merging mechanism is a filler layer with particles filled inside the dope reservoir.

17. The hollow fiber membrane-spinning nozzle according to claim 11, wherein the dope flow channel is configured to have a dope reservoir where the film-forming dope is stored in a ring shape on the outer side of the substrate insertion hole, and the dope reservoir is vertically divided into two or more storage cells.

18. The hollow fiber membrane-spinning nozzle according to claim 13, wherein a delay mechanism is formed in the dope flow channel to delay the passage of a film-forming dope, and the delay mechanism is configured to be a meandering portion that causes the film-forming dope to meander vertically between the dope reservoir and the dope shaping portion for forming the film-forming dope into a tube shape.
